(19) United States
(12) Patent Application Publication
(10) Pub. No.: US 2017/0115124 A1
(43) Pub. Date: Apr. 27, 2017

(54) Driver Workload Prediction and Path Routing

(71) Applicant: Ford Global Technologies, LLC, Dearborn, MI (US)

(72) Inventor: Jonathan Thomas Mullen, Palo alto, CA (US)

(21) Appl. No.: 14/919,532

(22) Filed: Oct. 21, 2015

(51) Int. Cl. G01C 21/34; G01C 21/36

(52) U.S. Cl. CPC G01C 21/3415; G01C 21/3484; G01C 21/3697; G01C 21/3667

(57) ABSTRACT

Methods, systems, and apparatuses for automated driving or for assisting a driver and for determining driver workload prediction as a function of a driving route or path are disclosed. A system includes a predicted workload component, a route component, and a notification component. The predicted workload component is configured to determine that at least one section of a current route comprises a high driver workload. The route component is configured to modify the current route to generate an alternate route, wherein the alternate route avoids the at least one section that comprises a high driver workload. The notification component is configured to provide the alternate route to a driver or automated driving system.

### TECHNICAL FIELD

The disclosure relates generally to methods, systems, and apparatuses for automated driving or for assisting a driver, and more particularly relates to methods, systems, and apparatuses for determining driver workload prediction as a function of a driving route or path.

### BACKGROUND

Automobiles provide a significant portion of transportation for commercial, government, and private entities. Due to the high cost and value of automobiles and potential harm to passengers and drivers, driver safety and avoidance of collisions or accidents are extremely important. In some cases, specific areas or sections of roads may experience higher accident rates due to road design, environmental factors, or other factors that make driving more difficult and/or dangerous at those locations.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an implementation of a system for reducing a driver workload;

FIG. 2 illustrates a road map with an example driving route;

FIG. 3 illustrates a road map with another example driving route;

FIG. 4 is a schematic block diagram illustrating example components of a workload component, according to one implementation;

FIG. 5 is a schematic block diagram illustrating a method for reducing a workload on a driver or automated driving system, according to one implementation;

FIG. 6 is a schematic block diagram illustrating another method for reducing a workload on a driver or automated driving system, according to one implementation; and

FIG. 7 is a schematic block diagram illustrating another method for reducing a workload on a driver or automated driving system, according to one implementation.

### DETAILED DESCRIPTION

In some cases, accidents or near accidents are the result of driver workload, or the demands on a driver's attention. Even if a driver's workload is not high enough to lead to dangerous driving, high workload on a driver leads to the driver arriving at a destination fatigued or in an agitated manner. Thus, in some situations, it may be desirable to predict driver workload. The present disclosure provides systems, methods, and devices that may be used to predict a driver workload of a candidate path. The predicted driver workload may be a scalar value or may be a referenced by location. The predictor may work by simulating a candidate path with a model of driver workload.

As an example, a routing algorithm may include driver workload in the cost of each path. Paths that include a high workload or overall high cost may be avoided to reduce the likelihood that large demands will be placed on the driver. In one embodiment, a driver may be re-routed to an alternate path based on a time, distance, and/or workload of a current path. As another example, a vehicle infotainment system may limit demands on the driver's attention based on expected workload. The prediction may be used to limit demands placed on the driver by the infotainment system. For example, the system may avoid seeking the driver's attention with an alert if it believes the driver is about to make a difficult turn or merge onto the freeway.

Where some instantaneous estimate of driver workload is available during a drive, it may be measured and stored in a map. For example, the map data or a driving history may be updated to include the workload experienced by the driver. The map of driver workloads may be used to form a personalized driver workload predictor, or it may be aggregated on a server as a cloud service for a plurality of vehicles. In one embodiment, a map of driver workloads may be used to improve a driver workload model, improving prediction power.

Driver workload can be a complex function of a number of factors. Many of these factors are themselves functions of vehicle path such as turns, deceleration events, speed, traffic, sun-load (e.g., the direction and angle of the sun on a vehicle), road type, lane changes, and the like. Many of these factors about a vehicle path may be inferred from a map's geometry or metadata layers. Other factors may only be readily available from other information such as from a driving history, aggregated data from a large number of drivers or accidents, or other information.

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, in-dash computers, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

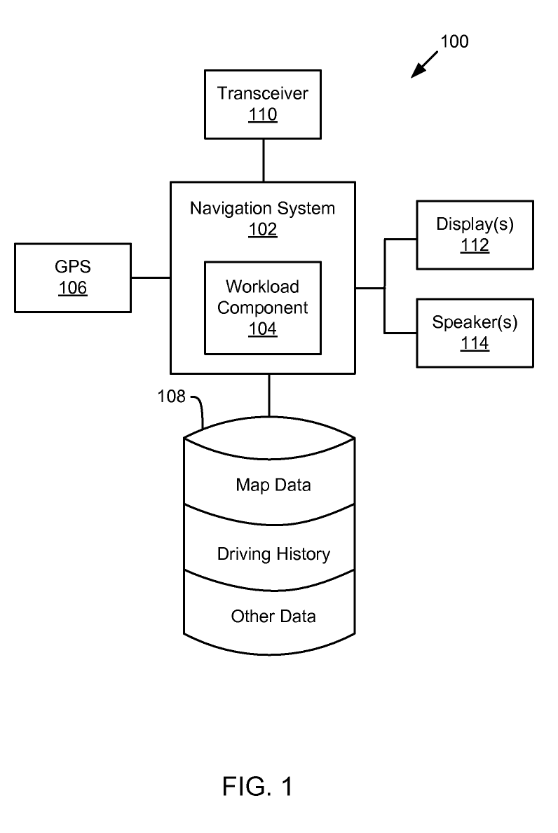

Referring now to the figures, FIG. 1 illustrates a system 100 for assisting a human driver or automated driving system that includes a navigation system 102. The navigation system 102 may be used to determine driving routes, driving paths, and/or provide turn-by-turn instructions to a human driver or automated driving system to arrive at a desired or predicted destination. For example, a human driver may be notified of navigation instructions or routes via visual, audio, or other interface to communicate with the human driver. For automated driving systems, electronic messages or signals may be provided to the automated driving system to follow a defined path. The navigation system 102 includes a workload component 104 that may be used to determine an estimated or actual workload for a user on a given path. The workload component 104 may also provide an alternate route if a given path has a workload or cost that exceeds that of the alternate route.

The system 100 also includes a global positioning system (GPS) 106, or other positioning system, to determine a current location of the vehicle. For example, the system 100 may be included as part of a vehicle itself. The system 100 may include a data store 108 for storing relevant or useful data for navigation and safety such as a driving history, map data, or other data. The system 100 may also include a transceiver 110 for wireless communication with a mobile or wireless network, other vehicles, infrastructure, or any other communication system. The system 100 may also include one or more displays 112, speakers 114, or other devices so that notifications to a human driver or passenger may be provided. The display 112 may include a heads-up display, dashboard display or indicator, a display screen, or any other visual indicator, which may be seen by a driver or passenger of a vehicle. The speakers 114 may include one or more speakers of a sound system of a vehicle or may include a speaker dedicated to driver notification.

It will be appreciated that the embodiment of FIG. 1 is given by way of example only. Other embodiments may include fewer or additional components without departing from the scope of the disclosure. For example, some systems 100 may include vehicle control systems to provide automated driving, collision avoidance, or other functions. For example, sensors such as radar, ultrasound, light ranging and detection (LIDAR), cameras or other sensors may be used to observer an environment around the vehicle and control acceleration, braking, steering, or other driving aspects of the vehicle. Additionally, illustrated components may be combined or included within other components without limitation. For example, the workload component 104 may be separate from the navigation system 102 and the data store 108 may be included as part of the navigation system 102 and/or part of the workload component 104.

The GPS system 106 is one embodiment of a positioning system that may provide a geographical location of the vehicle based on satellite or radio tower signals. GPS systems 106 are well known and widely available in the art.

The data store 108 stores map data, a driving history, and other data, which may include other navigational data, settings, or operating instructions for the automated navigation system 102. The map data may include location data, such as GPS location data, for roads, parking lots, parking stalls, or other places where a vehicle may be driven or parked. For example, the location data for roads may include location data for specific lanes, such as lane direction, merging lanes, highway or freeway lanes, exit lanes, or any other lane or division of a road. The map data may also include location data for paths, dirt roads, or other roads or paths, which may be driven by a land vehicle.

The driving history (or drive history) may include location data for past trips or parking locations of the vehicle. For example, the driving history may include GPS location data for the previous trips or paths taken. As another example, the driving history may include distance or relative location data with respect to lane lines, signs, road border lines, or other objects or features on or near the roads. The distance or relative location data may be determined based on GPS data, radar data, LIDAR data, camera data, or other sensor data gathered during the previous or past trips taken by the vehicle. In one embodiment, the navigations system 102 is configured to log driving data to the data store 108 for and during any trips or drives taken by the vehicle.

The transceiver 110 is configured to send and receive signals from one or more other data or signal sources. The transceiver 110 may include one or more radios configured to communicate according to a variety of communication standards and/or using a variety of different frequencies. For example, the transceiver 110 may send or receive signals to or from other vehicles. Receiving signals from another vehicle is reference herein as vehicle-to-vehicle (V2V) communication. In one embodiment, the transceiver 110 may also be used to transmit information to other vehicles to potentially assist them in locating vehicles or objects. During V2V communication the transceiver 110 may receive information from other vehicles about their locations, other traffic, accidents, road conditions, or any other data that may assist the navigation system in navigating accurately or safely.

In one embodiment, the transceiver 110 may be used to send or receive data about driver workloads for specific roads or areas of roads. For example, the transceiver 110 may download information about driver workload for portions of a current or probable path of a vehicle. Similarly, the transceiver 110 may receive workload information for one or more alternate paths or portions of alternate paths. In one embodiment, the transceiver 110 may be used to provide communication between the system 100 and a mobile network, the Internet, a remote server or any other network or devices.

In one embodiment, the workload component 104 is configured to determine a workload for a specific path or portion of a specific path. The workload may be used to compare the specific path to other paths and/or to determine an optimal path that balances distance, time traveled, driver workload, or other factors. The workload component 104 may determine the workload based on a map or driving history stored in the data store 108 or based on information received from a remote server or cloud service via the transceiver 110.

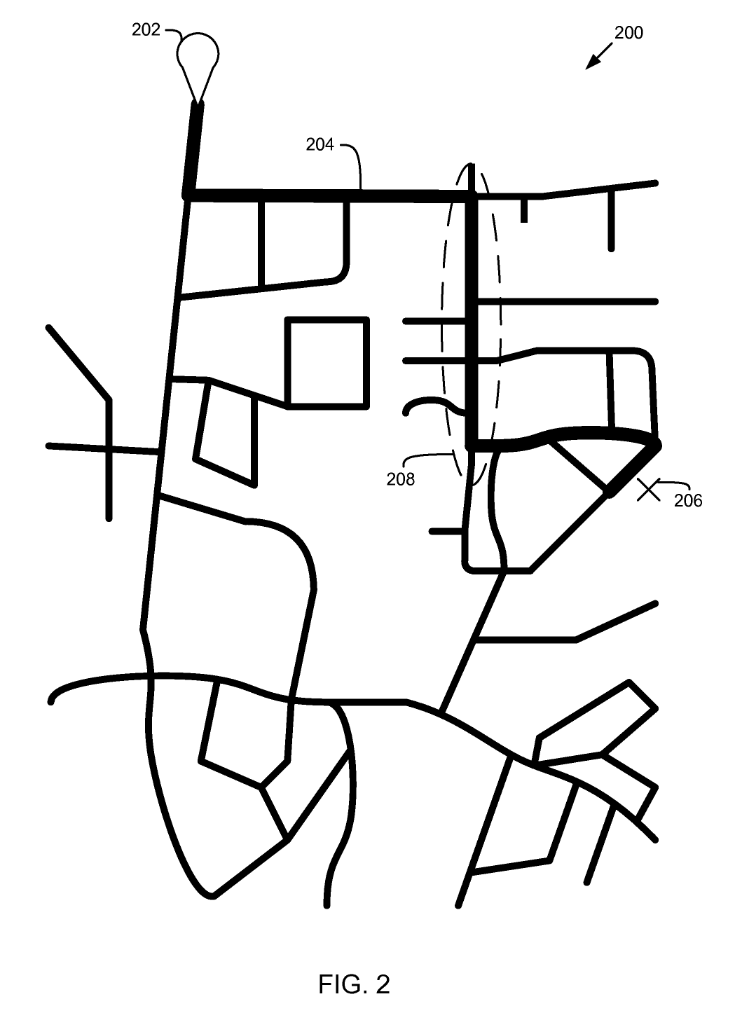

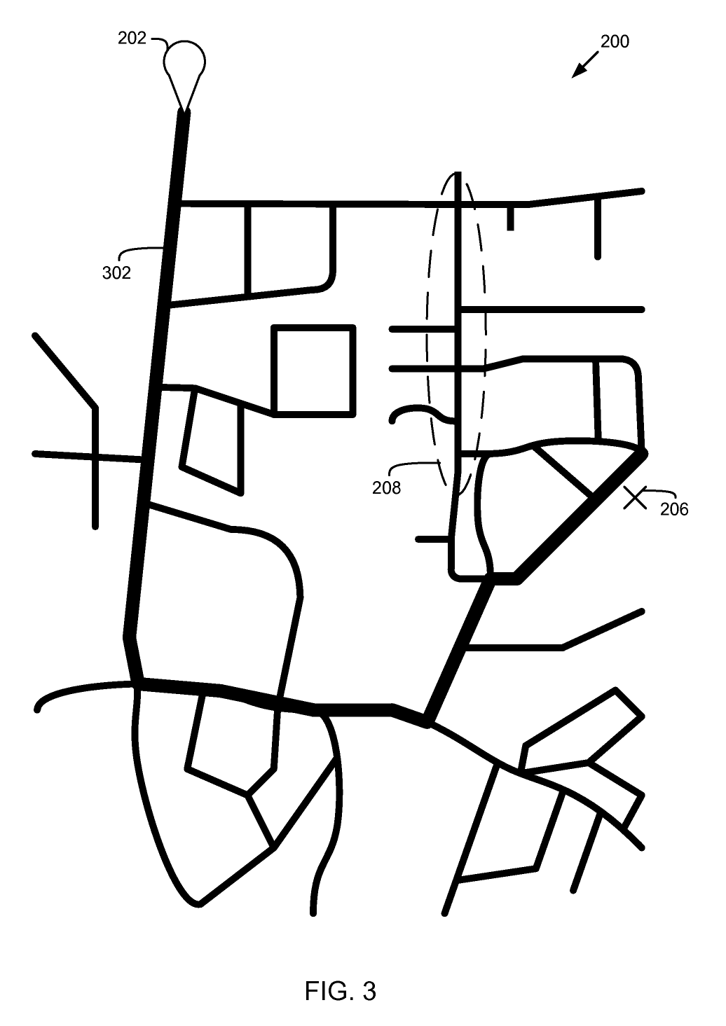

FIGS. 2-3 are line drawings illustrating an example road map 200 and example driving routes, which may be selected by a navigation system 102 or workload component 104. In FIG. 2, a first route 204 (shown as a bold line) between a position of the vehicle 202 and a destination 206 is illustrated. The first route 204 passes through a high workload segment 208, which may place high demands on the attention of a human or automated driver. For example, the workload component 104 may determine that the high workload segment 208 has a workload that exceeds a threshold value (e.g., a threshold value for a current driver or for drivers in general). FIG. 3 illustrates a second route 302 (shown as a bold line) between the position of the vehicle 202 and the destination 206. The second route 302 avoids the high workload segment 208 to arrive at the destination 206.

According to one embodiment, the workload component 104 may compare the two different routes to select a route with the lowest maximum workload or to select a route with a lowest cost. The cost of a route may be based on not only the workload of one or more segments, but also an overall distance. For example, the second route 302 may have a longer distance or driving time that the first route 202, but may still have a lower cost based on having lower driver workloads for its various segments.

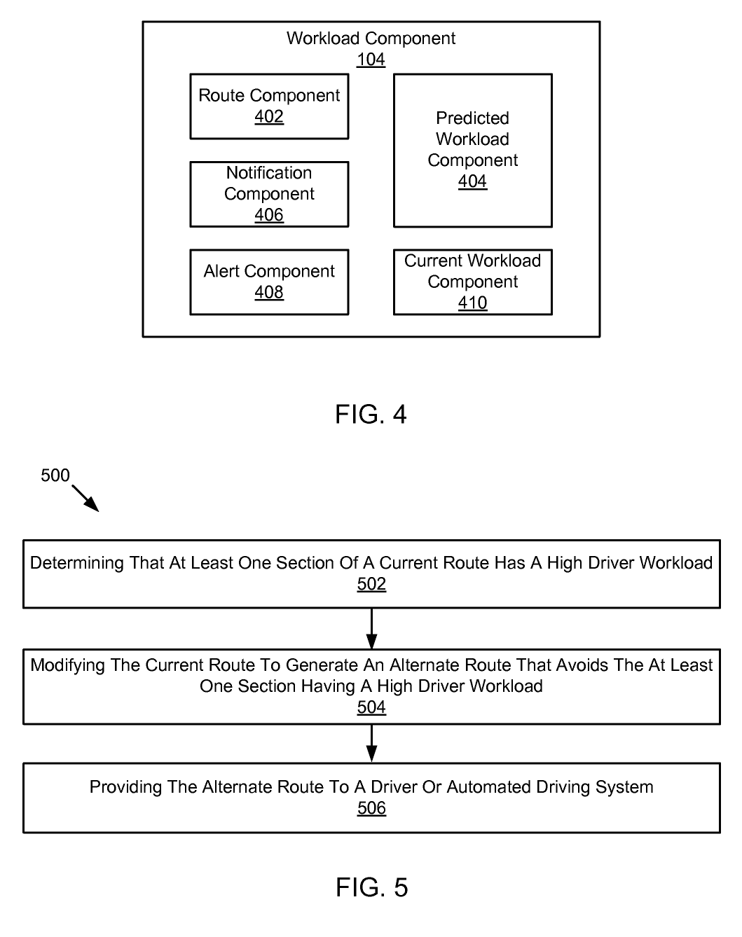

FIG. 4 is a schematic block diagram illustrating components of a workload component 104, according to one embodiment. The workload component 104 includes a route component 402, a predicted workload component 404, a notification component 406, an alert component 408, and a current workload component 410. The components 402-410 are given by way of illustration only and may not all be included in all embodiments. In fact, some embodiments may include only one or any combination of two or more of the components 402-410. Some of the components 402-410 may be located outside the workload component 104, such as within the navigation system 102 or elsewhere.

The route component 402 is configured to determine a route, or a potential route, for a vehicle to navigate. In one embodiment, the route component 402 may identify a plurality of possible routes to a specific destination. In one embodiment, the route component 402 may receive one or more routes from another component or system. For example, the route component 402 may receive one or more routes from a navigation system, such as the navigation system 102 of FIG. 1.

In one embodiment, the route component 402 is configured to determine a probable route for the vehicle. For example, the route component 402 may determine a probable route based on a driving history, instructions from a driver, information from a navigation system, or the like. In one embodiment, the route component 402 determines a probable route of a vehicle by identifying a likely destination for a specific vehicle or driver on at a specific time. For example, the route component 402 may identify a likely destination based on one or more of a time of day, a date, a day of the week, a scheduled appointment on a calendar, a driving history for the vehicle, a driving history for a driver, and a driving history of a passenger. In one embodiment, the route component 402 may compare a current, day, date, and time to a calendar or driving history to determine where the vehicle (and a driver or passenger) is going. For example, the route component 402 may determine that a driver is going to work because it is a weekday morning and a driving history indicates that the driver usually goes to work on weekday mornings. In one embodiment, route component 402 may identify a most frequently used route to travel to the likely destination as the probable route.

In one embodiment, the route component 402 is configured to modify a route to generate an alternate route. For example, the route component 402 may compare a highest workload segment of a current route to a highest workload segment of an alternate route and modify a route traveled by the vehicle from the current route to the alternate route if the highest workload segment of the alternate route has a lower workload than the highest workload segment of the current route. The workload values from one or more segments may be computed or received from the predicted workload component 404, which is discussed further below. As another example, the route component 402 may determine that one or more segments of a current route (or probable route) exceed a threshold workload value and may modify the current or probable route to avoid those one or more segments. The threshold workload value may be tuned by calibrators, such that the highest workload segments may be identified and potentially avoided. By avoiding the highest workload segments, even if travel time is increased, safety may be increased or a driver may be less stressed or anxious during driving.

In one embodiment, the route component 402 is configured to select a lowest cost route from a plurality of available routes. For example, the route component 402 may determine a cost of a route based on workload values for one or more segments of the routes as well as the lengths (in time or distance) of the routes and/or the one or more segments. In one embodiment, the route cost increases proportionally with route length and also increases in proportion with route attention demands (e.g., workload). In one embodiment, a route with a low total workload, but a long distance may have a lower cost than another route with a short distance, but higher workload. In one embodiment, the route component 402 selects a lowest cost route from a plurality of available routes. In one embodiment, if a route has already been selected (e.g., by a driver) or if it is determined that a driver is taking a probable route to a destination, the route component 402 may modify the current route or select an alternate route that has a workload lower than the current or probable route.

The predicted workload component 404 is configured to determine a workload for a route before the route is driven by a vehicle. For example, the predicted workload component 404 may predict workloads for one or more segments of a route before the vehicle arrives at those segments of the route. Predicting the workload may allow for increased intelligence in planning routes because workloads can be anticipated and high-workload areas can be completely avoided, if possible or necessary. In one embodiment, the predicted workload component 404 may determine workload values for each segment of a route and/or a workload value for an overall route.

The predicted workload component 404 may determine or calculate a workload based on a variety of factors. Example factors include information about turns such as a number of turns, the presence of left had turns, a number of left hand turns, the angle of turns, the amount of traffic at one or more turns, the presence or absence of a traffic signal at one or more turns, a number of intersecting roads (e.g., 3-way intersections, 4-way intersections, 5-way or more intersections), or any other information about turns or intersections. For example, 5-way intersections may have a higher workload (higher demands on drivers attention) than a 3-way or 4-way intersection. Similarly, left hand turns on U.S. roads without a signal may be more challenging than right-hand turns or left-hand turns with a signal. An additional factor may include lane changes along the route. For example, merging onto or exiting a roadway may cause higher workloads for a driver because they must watch out for other vehicles during lane changes, exits, and merges. Furthermore, a distance required in which to change lanes may also increase a workload. For example, if a driver is required to merge onto a road and change lanes a plurality of times to make a turn or exit in only a short distance, this can put a large workload on the driver.

Further example factors in calculating a workload include the presence of deceleration events. Deceleration events may include the presence of intersections with stop signs, traffic signals, or with routes that require turning at an intersection. A larger number of deceleration events may lead to higher workload as the driver must spend more time decelerating, accelerating, avoiding other accelerating/decelerating vehicles, or the like. Another example factor includes speed or speed limits on a road. Lower speed limits may lead to lower workload due to reduced required reaction times by drivers. In some situations, higher speed limits may lead to lower workloads because high speed limit roads tend to have fewer stops, merges, intersecting roads, or other road features that may require increased attention by a driver. In one embodiment, a factor in calculating a workload may include a road type, such as a state road, county road, wilderness road, interstate road, highway, freeway, residential, commercial, or other road classification. For example, a specific workload value or range may be assigned to each road type so that residential roads are avoided if a freeway is available.

The predicted workload component 404 may calculate a workload based on traffic. For example, the predicted workload component 404 may determine that a specific area has high or low traffic based on a driving history, map, time of day, or online resources. In one embodiment, the predicted workload component 404 may assign higher workload values to areas with high traffic and may reduce workload values for areas with lower traffic. Additionally, the predicted workload component 404 may calculate workload based on environmental conditions including sun-load, weather, time of day, or other factors. For example, a workload for an exact same location or may vary based on the time of day or direction of travel because the sun may make visibility difficult. Similarly, turns into the sun may cause a high workload as a driver gets situated, pulls down a sun visor, or otherwise is required to react to the sun.

The predicted workload component 404 may identify or determine these factors based on an electronic map, a driving history, a clock, a remote server, or any other source. For example, the predicted workload component 404 may reference a drive history to determine actual workloads experienced by a driver when driving a specific segment of road. As another example, the predicted workload component 404 may reference a map to determine information about turns, lane changes, direction of travel (e.g., for sun-load), population of surrounding areas, traffic information, or the like. The predicted workload component 404 may also access a database stored in the data store or available over a network that includes aggregated information about workloads. The aggregated workload information may include actual workloads experienced by a large number of different drivers at a specific portion of road and/or may include information about accident frequency. This information can be used to infer a workload for a specific segment of road. In one embodiment, the predicted workload component 404 may determine a workload specific to a current driver or vehicle. For example, the current driver may experience lower demands compared to the average driver and thus a workload value may be adjusted accordingly. An offset value for the driver may be stored and used to adjust any workload value based on other factors. In one embodiment, the offset value may be selected by the driver. In one embodiment, the offset value may be selected based on an actual driver workload (i.e., as determined by the current workload component). For example, if the driver experiences an increased emotional or mental state compared with generic workload values from aggregated sources, the driver may have an offset value that increases a workload determined based on other factors.

The predicted workload component 404 may determine that at least one section of a current route comprises a high driver workload. For example, the predicted workload component 404 may determine that the section has a high driver workload based on one or more of map geometry, a driving history, time of day, or any other factors disclosed herein. The workload value may be provided to the route component 402 or calculating of a route cost or for selection of a route that avoids or uses a specific segment of road.

The notification component 406 is configured to provide an indication of the workload estimate or modified route to a human driver or a navigation system of the vehicle. For example, the notification component may provide an alternate route to a driver or automated driving system. The alternate route, or instructions for the alternate route, may be presented on a display 112 or a speaker 114 of the system 100 of FIG. 1. For example, the alternate route may avoid the portion of a probable route that has a high workload. The instructions to the driver or an automatic driving system may follow a lowest cost driving route available to a specific destination. Thus, the driver or automated driving system may be able to drive the vehicle to avoid high workload segments.

The alert component 408 is configured to delay alerts during when the user is driving in high workload segments. In one embodiment, the alert component 408 is configured to anticipate a high workload will occur within a threshold time period and delay delivery of the alert to the driver until the driver workload falls below a threshold. In one embodiment, the alert component 408 determines that a high demand on an attention of the driver will occur within a threshold time period. For example, the alert component 408 may delay delivery of an alert to the driver until attention demands fall below a threshold.

The current workload component 410 is configured to determine a current driver workload. For example, the current workload component 410 may track recent and current driving maneuvers and current and recent locations to determine a current driver workload for a driver. The driving maneuvers and locations may be determined based on a positioning sensor (such as GPS), a map, and/or a driving history. In one embodiment, a camera or other sensor may be used to track a mental or emotional state of a driver. The current workload component 410 may determine an actual workload specific to the driver. In one embodiment, the current driver workload may be stored in the driving history, map, or other data of a data store 108. This information may be used later for calculating a workload specific to a driver, or as data to be aggregated for calculating generic or specific workloads for other drivers. In one embodiment, the current workload component 410 may transmit the current driver workload and current location over a network for storage in a workload database. For example, the workload database may aggregate data from a plurality of drivers or vehicles so that workload values can be accurately determined even if a vehicle has never driven over a specific portion of road before.

Referring now to FIG. 5, a schematic flow chart diagram of a method 500 for modifying a route based on driver workload is illustrated. The method 500 may be performed by a navigation system or a workload component, such as the navigation system 102 of FIG. 1 or the workload component 104 of FIG. 1 or 4.

The method 500 begins and a predicted workload component 404 determines at 502 that at least one section of a current route comprises a high driver workload. A route component 402 modifies at 504 the current route to generate an alternate route. The alternate route avoids the at least one section that has a high driver workload. The notification component 406 provides at 506 the alternate route to a driver or automated driving system.

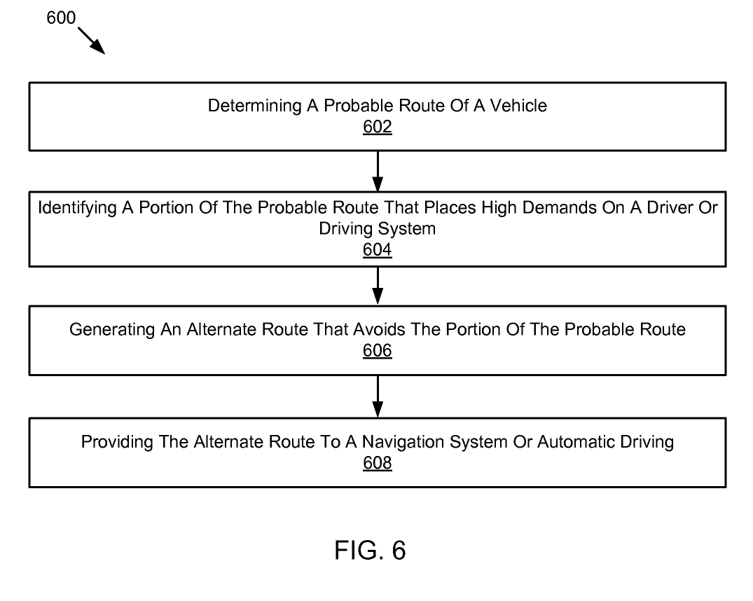

Referring now to FIG. 6, a schematic flow chart diagram of a method 600 for reducing driver workload is illustrated. The method 600 may be performed by a navigation system or a workload component, such as the navigation system 102 of FIG. 1 or the workload component 104 of FIG. 1 or 4.

The method 600 begins and a route component 402 determines at 602 a probable route of a vehicle. For example, the route component 402 may determine at 602 the probable route based on a time of day, calendar, or the like. The predicted workload component 404 identifies at 604 a portion of the probable route that places high demands on an attention of a driver or driving system. For example, the predicted workload component 404 may calculate a workload value for the portion and determine that it exceeds a threshold for the driver or automated driving system. The route component 402 generates at 606 an alternate route that avoids the portion of the probable route. The notification component 406 provides at 608 the alternate route to a navigation system or automatic driving system. A driver or automatic driving system may follow the alternate route to avoid the portion of the probable route that places high demands on an attention of a driver or driving system.

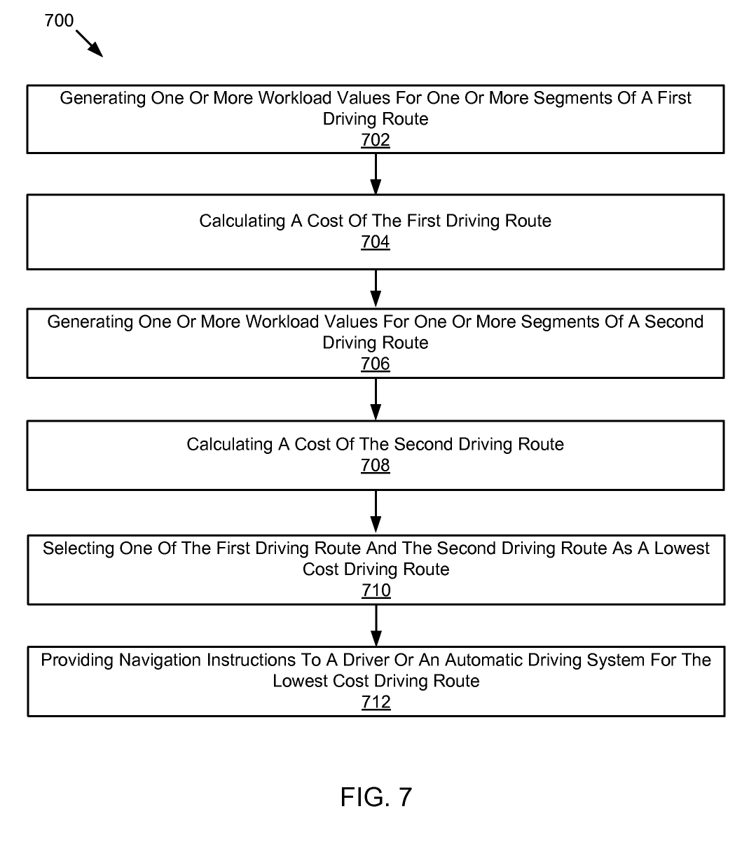

Referring now to FIG. 7, a schematic flow chart diagram of a method 700 for reducing a workload on a driver or automated driving system is illustrated. The method 700 may be performed by a navigation system or a workload component, such as the navigation system 102 of FIG. 1 or the workload component 104 of FIG. 1 or 4.

The method 700 begins and a predicted workload component 404 generates at 702 one or more workload values for one or more segments of a first driving route. A route component 402 calculates at 704 a cost of the first driving route based on a distance of the first driving route and the one or more workload values of the first driving route. The predicted workload component 404 generates at 706 one or more workload values for one or more segments of a second driving route. The route component 402 calculates at 708 a cost of the second driving route based on a distance of the second driving route and the one or more workload values of the second driving route. The route component 402 selects at 710 one of the first driving route and the second driving route as a lowest cost driving route. The notification component 406 provides at 712 navigation instructions to a driver or an automatic driving system to follow the lowest cost driving route. For example, the notification component 406 may provide 712 the navigation instructions to the driver or automatic driving system by providing an indication of the lowest cost route to a navigation component or automatic driving system.

### EXAMPLES

The following examples pertain to further embodiments.

Example 1 is a system that includes a predicted workload component, a route component, and a notification component. The predicted workload component is configured to determine that at least one section of a current route comprises a high driver workload. The route component is configured to modify the current route to generate an alternate route, wherein the alternate route avoids the at least one section that comprises a high driver workload. The notification component is configured to provide the alternate route to a driver or automated driving system.

In Example 2, the predicted workload component of Example 1 is configured to determine that at least one section of a current route includes a high driver workload based on one or more of turns, deceleration events, speed, traffic, sun-load, road type, and lane changes on the at least one section.

In Example 3, the predicted workload component of any of Examples 1-2 is configured to determine that at least one section of a current route includes a high driver workload based on map geometry.

In Example 4, the predicted workload component of any of Examples 1-3 is configured to determine that at least one section of a current route includes a high driver workload based a driving history.

In Example 5, the predicted workload component of any of Examples 1-4 is configured to determine that at least one section of a current route includes a high driver workload based on an estimated time of day during which the vehicle will be at the at least one section.

In Example 6, the predicted workload component of any of Examples 1-5 is configured to determine that at least one section of a current route includes a high driver workload based on workload data corresponding to the at least one segment received from a wireless network.

In Example 7, system of any of Examples 1-6 further includes a current workload component configured to determine a current driver workload for a current location.

In Example 8, the current workload component in Example 7 is configured to one or more of: store the current driver workload as associated with the current location a in a driving history; and transmit the current driver workload and current location over a network for storage in a workload database.

In Example 9, the system of any of Examples 1-8 further includes an alert component that is configured to anticipate a high workload will occur within a threshold time period and delay delivery of the alert to the driver until the driver workload falls below a threshold.

Example 10 is method comprising for reducing a workload on a driver, automated driving system, or automated assistance system (e.g., a navigation system 102). The method includes determining a probable route of a vehicle and identifying a portion of the probable route that places high demands on an attention of a driver or driving system. The method includes generating an alternate route that avoids the portion of the probable route. The method further includes providing the alternate route to a navigation system or automatic driving system that avoids the portion of the probable route.

In Example 11, determining the probable route in Example 10 includes identifying a likely destination based on one or more of the time of day, a date, a day of the week, a scheduled appointment on a calendar, a driving history for the vehicle, a driving history for a driver, and a driving history of a passenger.

In Example 12, determining the probable route in any of Examples 10-11 includes identifying a most frequently used route to travel to the likely destination.

In Example 13, identifying the portion of the probable route in any of Examples 10-12 includes determining that at least one section of the probable route comprises a high driver workload based on turns, deceleration events, speed, traffic, sun-load, road type, and lane changes on the portion of the probable route.

In Example 14, generating the alternate route in any of Examples 10-13 includes one or more of: calculating a cost of the probable route and one or more potential alternate routes based on route length and attention demands; and selecting the alternate route with a lowest cost from the probable route and the one or more potential alternate routes; wherein the route length comprises one or more of a drive time and a drive distance, wherein the cost increases with route length, and wherein the cost increases with route attention demands.

In Example 15, the method of any of Examples 10-14 further includes determining current attention demands of a driver for a current location of the vehicle while driving.

In Example 16, the method further includes one or more of: storing the current attention demands of the driver as associated with the current location a in a driving history; and transmitting the current attention demands and the current location over a network for storage in a workload database.

In Example 17, the method of any of Examples 10-16 further include determining that a high demands on an attention of the driver will occur within a threshold time period and delaying delivery of an alert to the driver until attention demands fall below a threshold.

Example 18 is a computer readable storage media storing instructions that, when executed by one or more processors, cause the processors to generate one or more workload values for one or more segments of a first driving route and to calculate a cost of the first driving route based on a distance of the first driving route and the one or more workload values of the first driving route. The computer readable storage media stores instructions that cause the processor generate one or more workload values for one or more segments of a second driving route and calculate a cost of the second driving route based on a distance of the second driving route and the one or more workload values of the second driving route. The computer readable storage media stores instructions that cause the processor to select one of the first driving route and the second driving route as a lowest cost driving route. The computer readable storage media stores instructions that cause the processor provide navigation instructions to a driver or an automatic driving system to follow the lowest cost driving route.

In Example 19, the instructions in Example 18 further cause the processor to generate the one or more workload values for the one or more segments of the first driving route and the second driving route based on one or more of turns, deceleration events, speed, traffic, sun-load, road type, and lane changes on the one or more segments.

In Example 20, the first driving route in any of Examples 18-19 include a current driving route and the second driving route comprises an alternate driving route, and the lowest cost driving route comprises the second driving route.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

Embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A system comprising:
a predicted workload component configured to determine that at least one section of a current route comprises a high driver workload;
a route component configured to modify the current route to generate an alternate route, wherein the alternate route avoids the at least one section that comprises a high driver workload; and
a notification component configured to provide the alternate route to a driver or automated driving system of a vehicle.

2. The system of claim 1, wherein the predicted workload component is configured to determine that at least one section of a current route comprises a high driver workload based on one or more of turns, deceleration events, speed, traffic, sun-load, road type, and lane changes on the at least one section.

3. The system of claim 1, wherein the predicted workload component is configured to determine that at least one section of a current route comprises a high driver workload based on map geometry.

4. The system of claim 1, wherein the predicted workload component is configured to determine that at least one section of a current route comprises a high driver workload based a driving history.

5. The system of claim 1, wherein the predicted workload component is configured to determine that at least one section of a current route comprises a high driver workload based on an estimated time of day during which the vehicle will be at the at least one section.

6. The system of claim 1, wherein the predicted workload component is configured to determine that at least one section of a current route comprises a high driver workload based on workload data corresponding to the at least one segment received from a wireless network.

7. The system of claim 1, further comprising a current workload component configured to determine a current driver workload for a current location.

8. The system of claim 7, wherein the current workload component is configured to perform one or more of:
store the current driver workload as associated with the current location a in a driving history; and
transmit the current driver workload and current location over a network for storage in a workload database.

9. The system of claim 1, further comprising an alert component configured to anticipate a high workload will occur within a threshold time period and delay delivery of the alert to the driver until the driver workload falls below a threshold.

10. A method comprising:
determining a probable route of a vehicle;
identifying a portion of the probable route that places high demands on an attention of a driver or driving system;
generating an alternate route that avoids the portion of the probable route; and
providing the alternate route to a navigation system or automatic driving system that avoids the portion of the probable route.

11. The method of claim 10, wherein determining the probable route comprises identifying a likely destination based on one or more of the time of day, a date, a day of the week, a scheduled appointment on a calendar, a driving history for the vehicle, a driving history for a driver, and a driving history of a passenger.

12. The method of claim 11, wherein determining the probable route comprises identifying a most frequently used route to travel to the likely destination.

13. The method of claim 10, wherein identifying the portion of the probable route comprises determining that at least one section of the probable route comprises a high driver workload based on turns, deceleration events, speed, traffic, sun-load, road type, and lane changes on the portion of the probable route.

14. The method of claim 10, wherein generating the alternate route comprises:
calculating a cost of the probable route and one or more potential alternate routes based on route length and attention demands; and
selecting the alternate route with a lowest cost from the probable route and the one or more potential alternate routes;
wherein the route length comprises one or more of a drive time and a drive distance, wherein the cost increases with route length, and wherein the cost increases with route attention demands.

15. The method of claim 10, further comprising determining current attention demands of a driver for a current location of the vehicle while driving.

16. The method of claim 15, further comprising one or more of:
storing the current attention demands of the driver as associated with the current location a in a driving history; and
transmitting the current attention demands and the current location over a network for storage in a workload database.

17. The method of claim 10, further comprising:
determining that a high demands on an attention of the driver will occur within a threshold time period; and
delaying delivery of an alert to the driver until attention demands fall below a threshold.

18. Computer readable storage media storing instructions that, when executed by one or more processors, cause the processors to:
generate one or more workload values for one or more segments of a first driving route;
calculate a cost of the first driving route based on a distance of the first driving route and the one or more workload values of the first driving route;
generate one or more workload values for one or more segments of a second driving route;
calculate a cost of the second driving route based on a distance of the second driving route and the one or more workload values of the second driving route;
select one of the first driving route and the second driving route as a lowest cost driving route; and
provide navigation instructions to a driver or an automatic driving system to follow the lowest cost driving route.

19. The computer readable storage media of claim 18, wherein the instructions cause the processor to generate the one or more workload values for the one or more segments of the first driving route and the second driving route based on one or more of turns, deceleration events, speed, traffic, sun-load, road type, and lane changes on the one or more segments.

20. The computer readable storage media of claim 18, wherein the first driving route comprises a current driving route and the second driving route comprises an alternate driving route, and wherein the lowest cost driving route comprises the second driving route.
